(19) United States
(12) Patent Application Publication
(10) Pub. No.: US 2012/0138113 A1
(43) Pub. Date: Jun. 7, 2012

(54) Foot rest with exercising and energy absorbing functions

(75) Inventors: KATHY SPINABELLA, Mundelein, IL (US); Ronald Spinabella, SR., Mundelein, IL (US); Roberta Singer, Newburyport, MA (US)

(73) Assignee: Classroom Seating Solutions, LLC, Lake Zurich, IL (US)

(21) Appl. No.: 13/114,038

(22) Filed: May 23, 2011

Related U.S. Application Data
(60) Provisional application No. 61/347,335, filed on May 21, 2010.

(51) Int. Cl. A47C 16/02; A61H 3/00; A47B 41/00; A47C 7/50; A47B 97/00

(52) U.S. Cl. 135/66; 297/423.1; 108/50.14; 297/423.42

(57) ABSTRACT

The present invention provides for a universal foot assembly having a foot pedal that may be attached to a desk or workstation that can be adjustably configured to allow for the foot pedal to vibrate, rotate, or move in a number of directions. The foot assembly comes as part of a kit and is configurable for retrofit attachment to existing desks and workstations. The foot assembly helps students having ADD or ADHD expend nervous energy. It also provides a valuable exercise mechanism for those trying to improve their physical health.

This application claims the benefit of U.S. Provisional Patent Application Ser. No. 61/347/335, filed May 21, 2010.

### FIELD OF THE INVENTION

This invention relates to creating an environment for a student that is conducive to the student's mental relaxation and to his physical body relaxation so that he or she can concentrate more easily, with fewer mental and physical distractions, in a scholastic environment, on his or her school work.

### BACKGROUND OF THE INVENTION

This invention is designed primarily for the students who are children to teenaged youth who are students in school, in classes ranging thereof from fourth grade in a grammar school, to seniors in their fourth year of high school.

The students necessarily will range in height from approximately forty-five inches to about seventy-eight inches. The main characteristic of each student will be the possession of excess energy, which prevents him or her from focusing their attention on the academic material being presented to them by the teacher.

Some students are very sluggish and tend to lay their heads on their desk or prop themselves or their head up on their elbows. Other students are so filled with energy that they can't stop their wiggles or stop bother their neighbors and preventing them from having their attention on what the teacher is presenting to the class. Both students need help in their preparation in the classroom to learn.

Recent studies have suggested that students' learning may be improved as a result of greater comfort and alteration of the desk, permits the student to stand while using the classroom desk. Teachers in several states have reported that they know from experience that standup desks facilitate the student's need to expend energy and at the same time focus better on their scholastic work rather than focusing on how to sit still or keep still.

Among the results reported from the studies are that activity permissive classrooms, including standup desks, give the children the flexibility they need to expend energy and at the same time focus better on their work as compared with students monitored while using traditional desks, wherein the researchers are looking for differences in physical activity and academic achievement.

### SUMMARY OF THE INVENTION

What is needed is an “activity permissive” classroom with standup desks that allow the children to have the flexibility they need to expend energy and at the same time focus better on their academic work so as to obtain the academic results the parents desire.

The instant invention utilizes a standup desk that combines the standup desk with a novel device called a “foot fidget” that in combination with the desk permits the student to expend energy in the classroom while focusing on his or her academic work without disturbing other fellow students present in the classroom.

The standup desk can be recycled present school desk with four metal legs. The desk can be a present school desk which is modified to lengthen the present legs to raise the desk's work level to a suitable height so that the students can stand and use the desk while the student is standing before the desk.

The instant invention can be attached to a walker, a workstation, a desk, or any piece of furniture that provides for enough clearance from the floor or ground to allow the “foot fidget” to rotate, vibrate, or move in a variety of directions without hitting the floor, or the ground, or the attached item.

A connector can be a turnbuckle or other equivalent devices for operational attachment to a desk, workstation, or a piece of furniture.

### DETAILED DESCRIPTION OF THE INVENTION

The invention allows the student to use a combination of a standup desk and a device called a “FootFidget.” The instant invention permits the student to have an enhanced learning environment for meeting the student needs and is conducive to the student's mental and physical relaxation so he or she can focus on his or her academic needs to obtain academic skills.

Because of the differing requirements of individual students in the academic environment, wherein the instant invention will be useful ranging from third or fourth grade in a grammar school setting to a high school environment of up to senior level in a four year high school environment. The standup desk will necessarily differ as to required leg height of the standup desk for each grade level. Each desk for each grade level, when a recycled desk for a specific grade level is used, will require that the four legs of the recycled, present school desk be lengthened so that the student can stand at the recycled school desk with extended legs.

The legs are necessarily extended by attaching tubular metal extensions to each leg with turn screw attachments wherein the leg extension can add up to twelve inches as an extension to each leg depending or added leg length need whether for a third or fourth grade classroom or a high school classroom.

The instant invention (12) is normally connected to a desk (2), or a workstation (3) [not shown], or a piece of furniture [not shown] (4), and it comes as a kit (10), See FIG. 5.

The instant invention may also come attached to a walker (30) or walking device, See FIG. 9; or as a standalone device (12), See FIGS. 7 & 8.

The instant invention or Footfidget (12) can be connected to a desk, workstation, piece of furniture, or any object where the user desires to have an exercise and energy absorbing function available. See FIG. 1.

The instant invention, or a Footfidget (12) is comprised of bungee cords (14A, 14B). While the bungee cords are the preferred material of choice, any elastomeric material having the elasticity and resiliency similar to the bungee cords is a suitable material, and can serve as a functional equivalent. The bungee cords are covered in outside covering or inner sleeve (16A, 16B) with a diameter slightly larger than the bungee cords (14A, 14B). See FIGS. 7 & 8.

The outside covering or inner sleeves (16A, 16B) has a diameter that is less than the outside sleeve (18). See FIG. 6 (bottom), See also FIGS. 2 & 3. The outside sleeve (18) couples the bungee cords to form a footrest, foot pedal, or footpad (20). See FIG. 2A.

The bungee cords are securably attached at first end (15A) and at a second end (15B) either directly or more likely by way of a connecting means (17). The connecting means (17) can be a number of mechanisms providing for a connection to the desk (2) or other standing object (5) [not shown]. The connecting means allows the bungee cords to operate “freely” as necessary for the vibration, elasticity, and resiliency, to allow the user to expend the necessary energy, to either relieve stress, or help exercise their lower torso, and strengthen their core muscular-skeletal system. As shown it FIGS. 2, 3A, 3B, and 3C the connecting means (17) are turnbuckles (11′), but can be clips, Velcro straps, heavy duty clamps, and other equivalent means with optional covers (19) to help prevent any damage to the desk, workstation, furniture or other standing object.

Option leg extensions (22) as shown in FIGS. 5 and 6, can be customized for any standing desk, workstation, or piece of furniture, so the distance between the floor or ground surface and the foot pedal (20) portion of the Footfidget (12) provides enough clearance to allow for the movement, extension, vibration, stretching, and other contortions of the foot pedal. Enough clearance or room is required for the exercising or extension of the foot pedal (20) of the FootFidget (12).

The combination of the foot pedal (20), the connecting means (17), optional legal extensions (22), and covers (19) all come in a kit (25).

The standalone unit would have the foot pedal (20); the connecting means (17), optional covers (19), all in a kit (27).

The connecting means (17) may be made of most any material, and can be powder coated if metallic in nature to avoid scratches against the desk legs, extensions, furniture, or workstation.

The footfidget kit provides for retrofitting attachment of extensions to an existing desk, workstation, furniture as is illustrated in FIG. 6. The function and purpose of the foot pedal (20) is to provide the advantages listed above. The footfidget assembly is generally u-shaped, having a pair of depending spaced bungee cords connected at each end, a first end, and a second end, by a connector means, to the existing desk, or workstation, each bungee cord is covered by an inner sleeve, and a pair of bungee cords are covered by an outer sleeve, forming a nexus at the approximate midpoint of the two bungee cords, whereby the bungee cords touch along their mid-points and form a foot pedal.

The foot pedal, with the connecting means help secure and stabilize the footfidget assembly.

The user receives significant benefits when using the instant invention, the user increases his or her exercise program, increases their core strengthening, increased circulation, burning calories, muscular activation are many of the benefits received from any protracted or long term use of the instant invention. By providing the user the freedom to exercise while otherwise performing a sedentary activity increased cardio, muscular, and skeletal benefits accrue.

While the instant invention has been described with reference to preferred embodiments, the invention is not to be limited to the described embodiments, or to the limit of options available, or to the use of specific components, configurations, or materials that might be described. All alternative or optional modifications, variations, or embodiments of the present assembly are included within the scope of this invention as set forth in the claims.

### BRIEF DESCRIPTION OF THE FIGURES

FIG. 1 illustrates the operation and installation of the food fidget and the manner of use of the foot fidget as attachment to the standup desk legs.

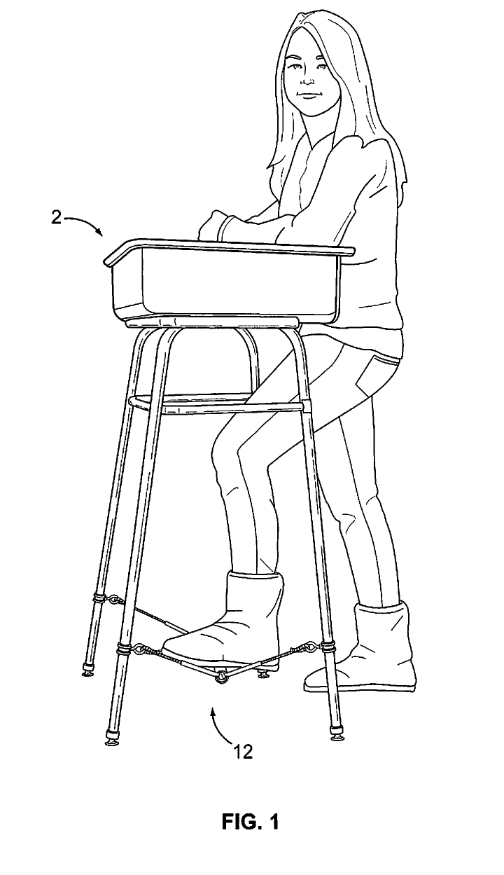

FIG. 2A illustrates the method of attachment of the invented device to the legs of the standup desk with the use of turnbuckles on each standup leg of the desk. Each leg has been lengthened by fitting a section of suitable pipe onto each leg to raise the desk section of the standup desk to a height suitable for use by the young girl shown in FIG. 1. The leg extension is not shown in FIG. 2A or in FIG. 1.

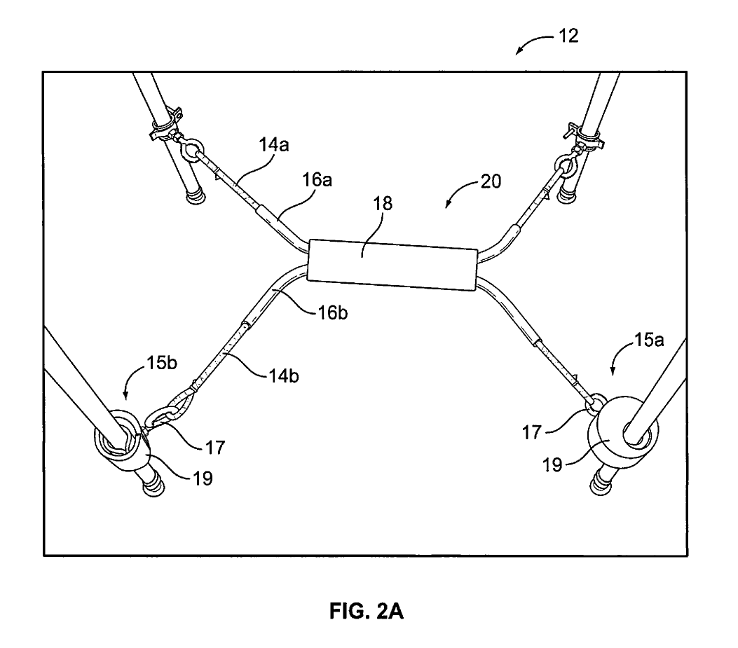

FIG. 2B shows the method by which the bungee cords of the foot fidget are coupled to form a spring mechanism wherein the bungee cords are passed through a two inch plastic cylinder to form the elastic foot rest or foot pedal of the food fidget held midway between the chair vertical legs of the standup chair as indicated in FIG. 1 and FIG. 2A.

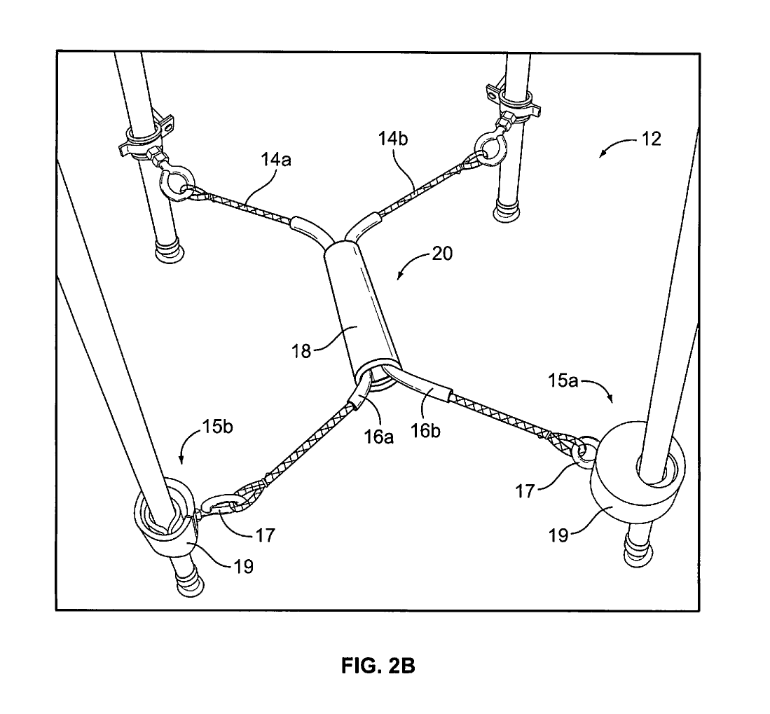

FIGS. 3A, 3B and 3C illustrate the method by which the ends of the bungee cords are attached to the four vertical legs of the standup desk using turn buckles and circular clamps.

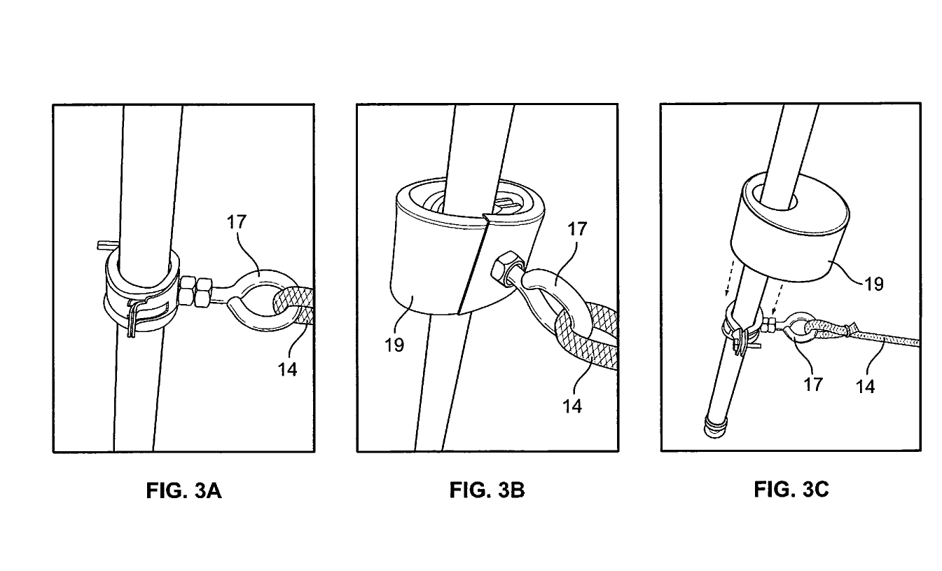

FIG. 4 illustrates how the bungee cords are passed through a two inch plastic cylinder to form the foot fidget foot stirrup which utilizes the energy of the bungee cords attached to the legs of the standup desk as the stirrup is bounced upward and down by the desk's operator as he or she utilizes his or her excess energy so that, as a study, he or she can concentrate more easily with fewer mental or physical distractions in an environment that is more conducive on the student's academic progress as the student's parents desire. The foot fidget is primarily directed to work with students who cannot sit still.

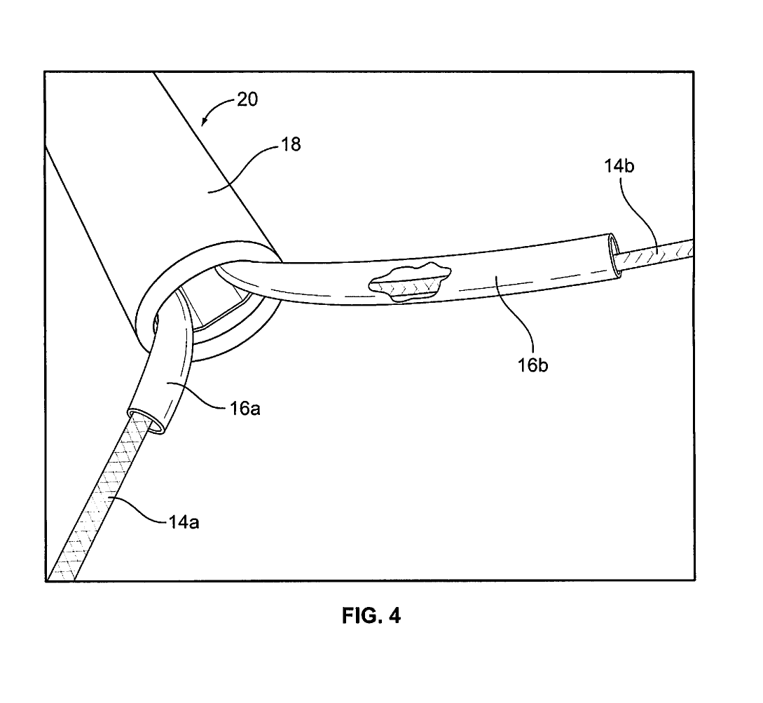

FIG. 6 shows the instant invention as a kit with the leg extensions for attachment to a standing desk.

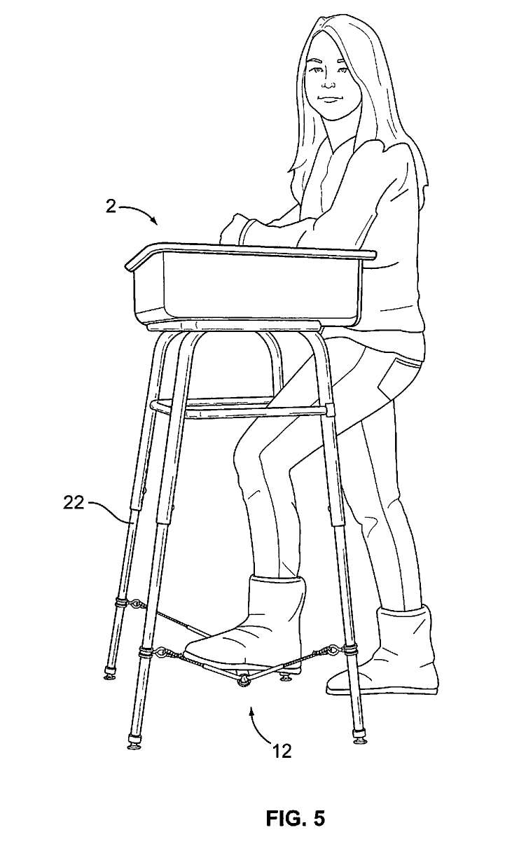

FIG. 7 shows the instant invention as a standalone piece of equipment.

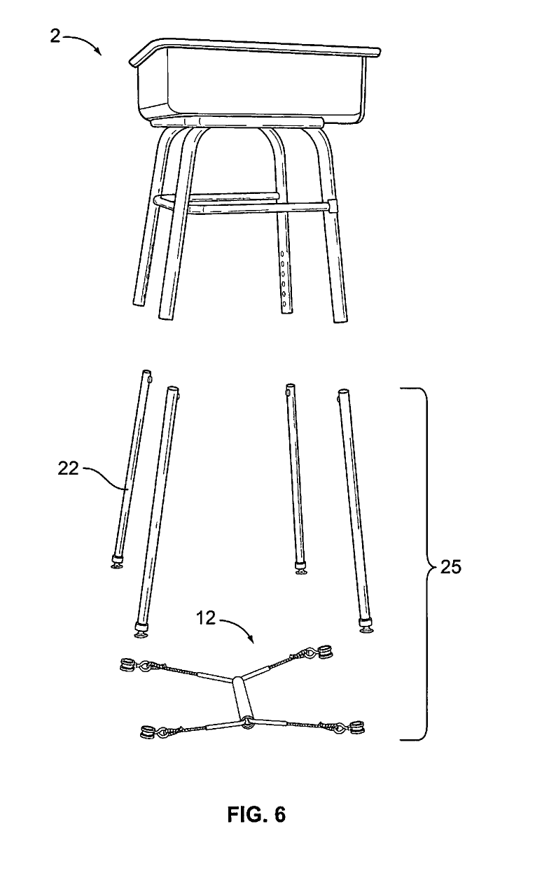

FIG. 8 shows the instant invention to expose the bungee cords by slitting the covers over the bungee cords.

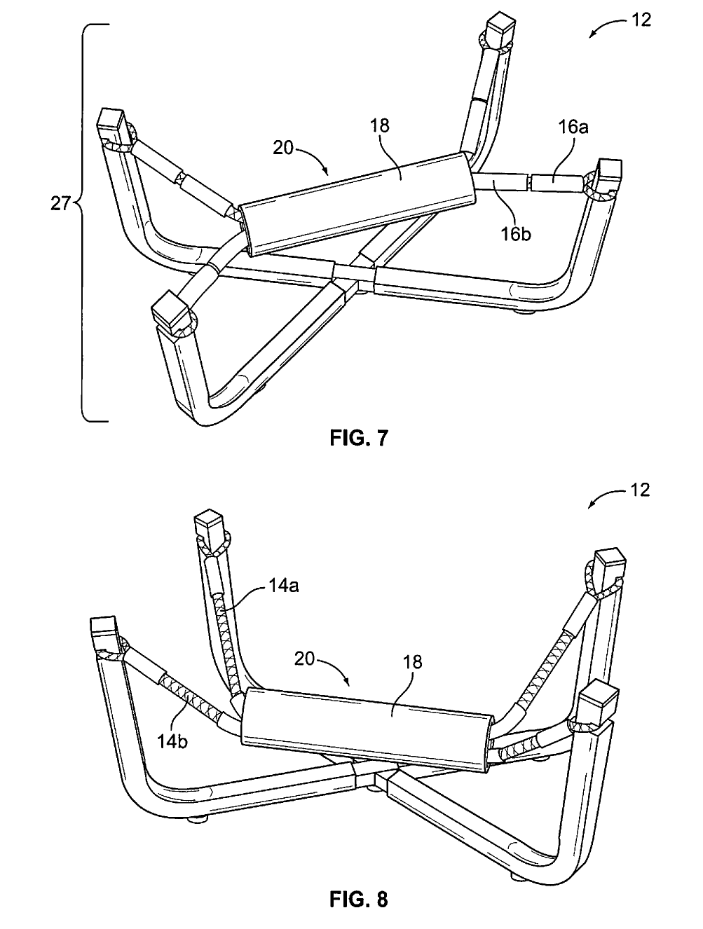

FIG. 9 shows the instant invention connected to an ordinary foot walker.

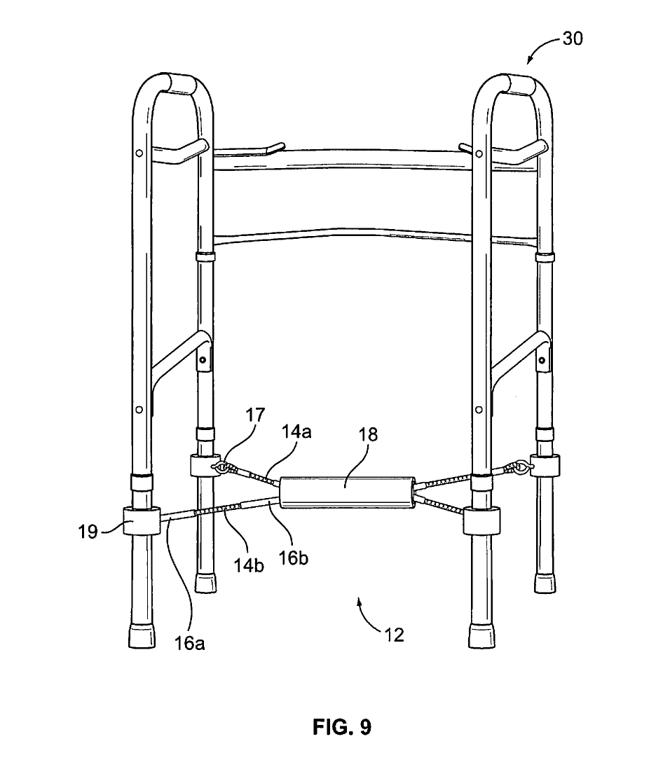

What is claimed is: The foot fidget is an invented device combination with a standup desk, wherein the invention consists of the system consisting of the foot fidget and a standup desk and the relationship between the foot fidget and the standup desk, wherein the foot fidget is an elastic stirrup for the student's foot to exercise his or her legs as he or she wishes in a permissive environment, wherein the desk is a recycled standard school desk with extended legs, the legs being lengthened with application of metal tubular sections to each leg to raise the level of the desk so that the student's foot in the foot fidget stirrups above floor level so the student can press down in the stirrup against the spring of the bungee cords attached to the foot fidget stirrups. Since the relationship between the foot fidget and the standup desk relates to the fact that the standup desk is required for application of the foot fidget and the standup desk operates best with application of the foot fidget in that the standup desk is required for application of the foot fidget by student, the instant invention comprises the combination of the two elements and is so claimed as the invention.

1. A device comprising:
a) A desk;
b) A plurality of legs for attachment to said desk;
c) A plurality of bungee cords, each bungee cord having a connector at each end;
d) Said connector of each bungee cord for connecting to the legs of the desk;
e) A holster for holding said bungee cords together;
f) Said holster and bungee cords creating a stirrup; and
g) Said stirrup from a start position able to vibrate or angulate in several degree positions without hitting a floor; said stirrup returning to a start position or to a stop position, said start and stop positions being the same.

2. A device comprising:
a) A desk having a plurality of legs;
b) A plurality of leg extensions for attachment to an extension for each said leg of said desk;
c) A plurality of bungee cords, each bungee cord having a connector at each end;
d) Said connector of each bungee cord for connecting to an extension of said legs of the desk;
e) A holster for holding said bungee cords together;
f) Said holster and bungee cords creating a stirrup; and
g) Said stirrup from a start position able to vibrate or angulate in several degree positions without hitting a floor; said stirrup returning to a start position or to a stop position, said start and stop positions being the same.

3. A device comprising;
a) A flat surface;
b) Said flat surface for placement on said pre-assembled footrest comprised of a footfidget:
c) Said footfidget comprising:
i) A plurality of legs for attachment to said flat surface;
ii) A plurality of bungee cords, each bungee cord having a connector at each end;
iii) Said connector of each bungee cord for connecting to the legs of the flat surface;
iv) A holster for holding said bungee cords together;
v) Said holster and bungee cords creating a stirrup; and
vi) Said stirrup from a start position able to vibrate or angulate in several degree positions without hitting a floor; said stirrup returning to a start position or to a stop position, said start and stop positions being the same.

4. A foot support assembly comprising:
a) A foot member;
b) A connector or connection assembly suitable for operative connection to a leg or plurality of legs of a desk or a piece of furniture having a plurality of legs;
c) said foot member or plurality of foot members operatively connected to a leg or plurality of legs of a desk or a piece of furniture having a plurality of legs; where said foot member resides above the ground or a floor for vibration and rotation;
d) said foot member or member connected to said plurality of legs of a desk or a piece of furniture for pivotal rotation and movement of said foot member about a first horizontal axis.

5. The foot support assembly as recited in claim 4, wherein the piece of furniture comprise a workstation, or a walker.

6. The foot support assembly as recited claim 4, wherein a connector or said connectors I configured for attachment to a support structure having or comprising an upper working surface.

7. The foot support assembly as recited in claim 4, wherein the connector or said connectors is a turnbuckle.

8. The foot support assembly as recited in claim 4, wherein the foot support assembly, the connectors, and option leg extensions are in kit form.

9. A foot support assembly comprising:
a.) A footrest portion further comprising:
i. a leg or a foot portion angularly extended away from a seat portion;
ii. a foot support portion distal from the seat portion;
iii. a connector further comprising:
a. a mechanism structured for translating the leg and foot support portions relative to the chair portion;
b. the connector being structured for moving the foot support assembly between the extended and retracted configurations, and rotations.

10. A support assembly comprising:
1. A footrest portion comprising:
2. A leg or foot portion angularly extended away from the seat portion; and terminating in a foot support portion;
3. A means for actuating the footrest portion between a relationship with the chair portion having the foot portion extended relative to the seat portion of the chair, and a retracted relationship having the foot portion retracted relative to the seat portion,
4. Wherein the means for actuating the footrest portion further comprises a connection mechanism coupled between the footrest portion and a desk, a workstation, or a piece of furniture;
5. a means for translating the foot support portions of the footrest portion relative to the chair portion between the deployed relationship and the retracted relationship.

11. A foot support assembly comprising:
1. A foot rest connection device comprising a bungee cord; forming a nexus to a second bungee cord,
2. Wherein the first bungee cord is placed through a sleeve; Said second bungee cord is placed through said same sleeve, forming a footrest;
3. Said bungee cords and said sleeve forming the footrest member;
4. Said footrest member connected by said connection means to a plurality of legs of a desk, or a workstation, or a piece of furniture;
5. Said footrest member, said connection means, optionally said plurality of desk leg extension form the foot support assembly.

12. The foot support assembly as recited in claim 11, wherein the foot support assembly, the connectors, and option leg extensions are in kit form.
